(19) United States
(12) Patent Application Publication
(10) Pub. No.: US 2026/0305648 A1
(43) Pub. Date: Oct. 8, 2026

(54) GUM BASE COMPOSITION CONTAINING NATURAL ORIGIN INGREDIENTS

(71) Applicant: TEKNOGUM DANISMANLIK VE DIS TICARET LIMITED SIRKETI, Istanbul (TR)

(72) Inventors: Nesim M. ACAR, Istanbul (TR); David ACAR, Istanbul (TR)

(73) Assignee: TEKNOGUM DANISMANLIK VE DIS TICARET LIMITED SIRKETI, Istanbul (TR)

(21) Appl. No.: 19/481,181

(22) PCT Filed: Mar. 7, 2024
(86) PCT No.: PCT/TR2024/050225

§ 371 Date: Nov. 4, 2025

(30) Foreign Application Priority Data
May 11, 2023 (TR) 2023/005253

(51) Int. Cl. A23G 4/08; A23G 4/06; A23G 4/10

(52) U.S. Cl. CPC A23G 4/08; A23G 4/068; A23G 4/10

(57) ABSTRACT

A gum base composition is provided, that does not contain any synthetic polymers, solvents and petroleum-derived components as raw materials, and thus contains natural origin ingredients and natural resource components suitable for consumption for environmental health. The rubber obtained from the Hevea Brasiliensis tree is suitable for use in gum production, is environmentally friendly, and provides flexibility and strength to ensure chewing properties for consumers; and the rubber obtained from the Hevea Brasiliensis tree and/or the at least one exudate paste provides conformational rigidity to a polymer backbone causing softness for the gum production in the natural rubber obtained from the Sapodilla tree as the natural elastomer component.

### CROSS REFERENCE TO THE RELATED APPLICATIONS

This application is the national phase entry of International Application No. PCT/TR2024/050225, filed on Mar. 7, 2024, which is based upon and claims priority to Turkish Patent Application No. 2023/005253, filed on May 11, 2023, the entire contents of which are incorporated herein by reference.

### TECHNICAL FIELD

The invention relates to the technical field of technological food, and a gum base composition that does not contain any petroleum-derived components, synthetic polymers and/or chemical solvents as raw materials, and thus contains natural origin ingredients and natural resource components suitable for consumption for environmental health.

The invention relates to a gum base composition in which the technical disadvantages of containing natural origin ingredients and natural source components as raw materials are eliminated.

### BACKGROUND

Gum base composition is the main material used in the production of gum. The elasticity, stickiness and chewing resistance of gum depend on the materials contained in the gum base composition. The gum base composition is the main ingredient of gum and can be combined with other additives (flavors, colorants, sugars, etc.) to produce the gum. The gum base composition can include many different materials. These may include synthetic polymers, synthetic or natural elastomers, plasticizers, softening solvents, emulsifiers, natural resins, paraffin waxes, beeswax, natural gums, fillers and other materials.

The gum base composition is one of the main raw materials of gum, which determines its durability, elasticity and chewing life. During the production of gum, other softeners, sweeteners, colorants and flavors are added to the gum base composition to obtain the final product.

In the relevant technical field, the synthetic polymers, solvents, petroleum-based softeners (paraffin wax, microcrystalline wax) are generally used as raw materials in the gum base composition. The materials such as polyisobutylene, polyvinyl acetate, styrene butadiene and polyethylene are used as said synthetic polymers.

In the art, the negative effects of using synthetic polymers as raw materials in the gum base compositions have been studied in great detail in recent years. The studies have found that the synthetic polymers cause negative environmental effects when used as raw materials in the gum base compositions. Therefore, in recent years, the food production standards have made progress in placing limits on the use of these synthetic polymer raw materials.

For this reason, it is thought that the skilled person in the relevant technical field should carry out research and development activities regarding the production of the gum base compositions that do not contain petroleum-derived components as raw materials but contain natural raw materials that can meet the current gum consumption conditions.

### SUMMARY

Petroleum-derived components are frequently used as raw materials in gum base compositions used in the gum production in the relevant technical field. The negative environmental effects of these petroleum-derived components have now been confirmed by the researches. Therefore, the strict food production standards are established in the current and future periods stating that these petroleum-derived components should not be included in the gum base compositions used in the gum production.

The inventors present a gum base composition that eliminates the technical problems and disadvantages that would occur by using the petroleum-derived components as raw materials. Therefore, the present invention relates to a gum base composition containing natural origin ingredients and natural source components as raw materials.

The primary object of the present invention is to provide a gum base composition that contains natural elastomer components and has the chewing and gum form properties suitable for consumers.

Another primary object of the present invention is to provide a gum base composition in which the technical problems and disadvantages that may occur by using natural elastomer components are eliminated and the embodiments are made for this purpose.

The secondary object of the present invention is to provide a gum base composition in which negative environmental effects are eliminated.

Another secondary object of the present invention is to provide a gum base composition in which the costs are not high.

Another secondary object of the present invention is to provide a gum base composition that is environmentally friendly and sustainable. The gum base of the invention does not contain petroleum-derived components and solvents.

### DETAILED DESCRIPTION OF THE EMBODIMENTS

In this detailed description, the subject of the invention relates to a gum base composition suitable for use in the gum production and is described only with the examples that will not create any limiting effect for a better understanding of the subject.

In another aspect, the invention relates to the gum products containing the gum base composition of the invention as raw material.

As is known in the art, the gum can be produced in many different final forms according to the demands of the consumer. Different ingredients such as sweeteners, colorants, fragrances and softeners can be added to the gum composition to provide various properties such as sweetening, coloring, smelling and hardness adjustment. This invention relates to the use of natural resource components instead of synthetic polymers, solvents and petroleum-derived components that determine their essential properties in gum base compositions used as raw materials in the gum production. Accordingly, in the invention, it may be possible to add different components to provide additional properties to the gum base composition obtained from natural origin ingredients and natural source polymer components. However, the scope of protection of this invention is independent of what the sweeteners, colorants, fragrances or softeners used in the gum production are and how much they are included in the gum compositions.

Accordingly, the gum base compositions of the invention are expected to have properties such as flexibility, stickiness, chewing resistance, long shelf life and processability so that they can be used as raw materials in the gums in the relevant technical field. In addition, as a result of the recent researches, it is expected that the gum base compositions will not have negative environmental effects.

The object of the inventors is to provide a gum base composition that meets the expected technical specifications for the gum production and does not create negative effects on environmental health simultaneously. The gum base composition of the invention contains at least one of natural rubber obtained from the Hevea Brasiliensis tree and/or the chicle group obtained from the Sapodilla tree as a natural elastomer component. In a preferred embodiment, the gum base composition of the invention may contain both natural rubber and/or chicle components obtained from the Sapodilla tree.

The rubber obtained from the Hevea Brasiliensis tree and/or the chicle obtained from the Sapodilla tree, included in the gum base composition of the invention, are/is a type of natural rubber, as is known in the art. Said ingredients are obtained from the sap (juice) of Hevea Brasiliensis trees and/or Sapodilla trees and have flexibility and durability suitable for use in the gums.

In the present invention, the gum base preferably contains at least one elastomer component in the range of 2% to 70% by weight. By adding natural elastomer components in targeted weight ratios, the final product of the gum base composition can achieve the expected performance. The gum base composition may contain at least one of or the mixture of the rubber obtained from the Hevea Brasiliensis tree and/or the chicle group obtained from the Sapodilla tree in the specified weight ratios as natural elastomer component.

Accordingly, as a technical solution for the relevant technical field, the inventors offer the use of natural elastomer components instead of petroleum-derived components contained in the gum bases used in the gum production and the use of rubber obtained from the Hevea Brasiliensis tree and/or naturel rubbers from chicle obtained from the Sapodilla tree as the natural elastomer component.

The gum base composition of the invention contains rubber obtained from the Hevea Brasiliensis tree and/or natural rubbers obtained from the Sapodilla tree as a natural elastomer component, and also contains at least one gum paste. In this invention, instead of gum paste, exudate paste, which is known to be used as a terminology in the relevant technical field, can also be used with the same meaning. The gum base composition of the invention contains rubber obtained from the Hevea Brasiliensis tree and/or natural rubbers obtained from the Sapodilla tree and a polyisoprene structure as a chemical functional group. It has been determined that the double bonds (C═C) in the natural rubber provide conformational rigidity to the polymer backbone, making it softer than the saliva content when the final product is chewed by the consumers. Therefore, the gum containing rubber obtained from the Hevea Brasiliensis tree and/or natural rubbers obtained from the Sapodilla tree as components has a stable and non-homogeneous chewing feature. In this invention, gum paste is used to prevent these technical problems. In this way, the chewing properties of rubber obtained from the Hevea Brasiliensis tree and/or natural rubber obtained from the Sapodilla tree in the gum are improved.

The gum base composition of the invention contains at least one gum paste suitable for rubber obtained from the Hevea Brasiliensis tree and/or natural rubber obtained from the Sapodilla tree. This invention contains at least one selected from the group of gum arabic, ghatti gum and/or tragacanth gum as thickeners (gum paste). The gum base composition of the invention contains at least one of or a mixture of several of the thickeners (gum paste).

As is known in the art, the thickeners (gum paste) are hydrocolloid polysaccharides. They are also natural resins obtained by tapping the trees. They have properties forming a viscous structure dissolving easily in water.

A gum base composition of the invention can contain gum paste at a value between 5% and 200% by weight of the natural elastomer component.

A gum base of the invention contains at least one natural elastomer component and at least one gum paste. However, this composition is not gum base yet. The production of the gum base in the invention is completed by using some or all of, but not limited to, natural or natural resource resins, softeners, emulsifiers, hydrogenated vegetable oils, antioxidants and fillers, which can also be used in the traditional gum base production.

The main embodiment of the invention is that the auxiliary components are obtained from the natural, that is, non-petroleum derived components. Thanks to all these, a gum base composition that is natural and does not create any negative technical impact on the environment can be produced.

The scope of protection of the invention is described in the attached claims and cannot be limited to what is explained in this detailed description for the exemplary purposes. It is clear that a person skilled in the art can produce similar embodiments in the light of what is explained above, without deviating from the main theme of the invention.

What is claimed is:

1. A gum base composition, comprising, instead of petroleum-derived components, a rubber obtained from Hevea Brasiliensis tree, and/or a natural rubber obtained from Sapodilla tree as a natural elastomer component, and/or at least one exudate paste, wherein the rubber obtained from the Hevea Brasiliensis tree is suitable for use in gum production, is environmentally friendly, and provides flexibility and strength to ensure chewing properties for consumers; and the rubber obtained from the Hevea Brasiliensis tree and/or the at least one exudate paste provides conformational rigidity to a polymer backbone causing softness for the gum production in the natural rubber obtained from the Sapodilla tree as the natural elastomer component.

2. The gum base composition according to claim 1, wherein the natural elastomer component is in a value ranging from 2% to 70% by weight.

3. The gum base composition according to claim 1, wherein the at least one exudate paste is at least one selected from the group consisting of gum arabic, ghatti gum, and/or tragacanth gum.

4. The gum base composition according to claim 3, wherein the at least one exudate paste is the gum arabic.

5. The gum base composition according to claim 1, wherein the at least one exudate paste is at a value between 5% and 200% by weight of the natural elastomer component.

6. The gum base composition according to claim 1, further comprising at least one of the following: a resin, a plasticizer, a natural wax, a hydrogenated oil, a natural emulsifier, a natural filler, and a herbal antioxidant.

7. A gum comprising the gum base composition according to claim 1.

8. The gum base composition according to claim 2, wherein the at least one exudate paste is at least one selected from the group consisting of gum arabic, ghatti gum, and/or tragacanth gum.

9. The gum base composition according to claim 2, wherein the at least one exudate paste is at a value between 5% and 200% by weight of the natural elastomer component.

10. The gum base composition according to claim 3, wherein the at least one exudate paste is at a value between 5% and 200% by weight of the natural elastomer component.

11. The gum base composition according to claim 4, wherein the at least one exudate paste is at a value between 5% and 200% by weight of the natural elastomer component.

12. The gum base composition according to claim 2, further comprising at least one of the following: a resin, a plasticizer, a natural wax, a hydrogenated oil, a natural emulsifier, a natural filler, and a herbal antioxidant.

13. The gum base composition according to claim 3, further comprising at least one of the following: a resin, a plasticizer, a natural wax, a hydrogenated oil, a natural emulsifier, a natural filler, and a herbal antioxidant.

14. The gum base composition according to claim 4, further comprising at least one of the following: a resin, a plasticizer, a natural wax, a hydrogenated oil, a natural emulsifier, a natural filler, and a herbal antioxidant.

15. The gum base composition according to claim 5, further comprising at least one of the following: a resin, a plasticizer, a natural wax, a hydrogenated oil, a natural emulsifier, a natural filler, and a herbal antioxidant.

16. The gum according to claim 7, wherein in the gum base composition, the natural elastomer component is in a value ranging from 2% to 70% by weight.

17. The gum according to claim 7, wherein in the gum base composition, the at least one exudate paste is at least one selected from the group consisting of gum arabic, ghatti gum, and/or tragacanth gum.

18. The gum according to claim 17, wherein in the gum base composition, the at least one exudate paste is the gum arabic.

19. The gum according to claim 7, wherein in the gum base composition, the at least one exudate paste is at a value between 5% and 200% by weight of the natural elastomer component.

20. The gum according to claim 7, wherein the gum base composition further comprises at least one of the following: a resin, a plasticizer, a natural wax, a hydrogenated oil, a natural emulsifier, a natural filler, and a herbal antioxidant.
